(19) United States
(12) Patent Application Publication
(10) Pub. No.: US 2011/0061352 A1
(43) Pub. Date: Mar. 17, 2011

(54) FILTER ARRANGEMENT WITH LATCHING V FLAPS

(75) Inventors: Ulrich STAHL, Laudenbach (DE); Uwe FELBER, Abtsteinach (DE); Claudio MARIN, St. Leon-Rot (DE)

(73) Assignee: CARL FREUDENBERG KG, Weinheim (DE)

(21) Appl. No.: 12/882,270

(22) Filed: Sep. 15, 2010

(30) Foreign Application Priority Data
Sep. 15, 2009 (DE) 10 2009 041 113.5

(51) Int. Cl. B01D 46/52

(52) U.S. Cl. 55/385.3

(57) ABSTRACT

A filter arrangement for filtering an air supply to a motor vehicle engine includes a filter element having a pleated filter medium, the pleated filter medium having an end face and a longitudinal side face, at least one of the end face and the longitudinal side face having a flap with a free end projecting from the respective face; and a filter housing receiving the filter element and having a housing wall, wherein the flap is configured to be placed tight against the housing wall.

### CROSS REFERENCE TO PRIOR APPLICATIONS

Priority is claimed to German Patent Application No. DE 10 2009 041 113.5, filed Sep. 15, 2009, the entire disclosure of which is incorporated by reference herein.

### FIELD

The invention relates to a filter arrangement for filtering the air supplied to a motor vehicle engine comprising a filter element with a pleated filter medium, the pleated filter medium having end faces and longitudinal faces, and comprising a filter housing for receiving the filter element, the filter housing having housing walls.

### BACKGROUND

Filter arrangements of the aforementioned type are known from the prior art. The filter elements used to filter the air supplied to a motor vehicle engine are conventionally provided with a polyurethane caterpillar track which rests tight against the housing walls. The polyurethane caterpillar track frequently has a width of 10 mm so that it can withstand air streams of 200 to 1,000 kg/h and pressure differences of 5 to 50 mbar between the inlet side and the outlet side of the filter element.

The filter elements known from the prior art have to ensure a reliable seal, even in the case of high air throughputs and high differential pressures greater than 20 mbar. In particular, the filter elements must provide a seal against dust.

In addition, it must be ensured with known filter arrangements that the filter element is pressed in the filter housing in such a way that the polyurethane caterpillar track rests sufficiently firmly against the housing walls.

The filter elements used in the known filter arrangements therefore have to be adapted in a complex manner to the dimensions of the filter housing, in order to ensure a reliable seal. In particular, it must be ensured that polyurethane caterpillar tracks are applied to the filter medium or the filter element in such a way that the polyurethane caterpillar track rests under sufficient pressure tight against a housing wall. This entails high costs, in particular on account of the high material costs for polyurethane and the procedures for applying the polyurethane caterpillar track.

### SUMMARY OF THE INVENTION

It is accordingly an aspect of the invention to configure and develop a filter arrangement of the type mentioned at the outset in such a way that, after assembly of a cost-effective filter element, a reliable seal is ensured between inlet side and outlet side, even in the case of high air throughputs and pressure differences.

The filter arrangement mentioned at the outset for filtering the air supplied to a motor vehicle engine is accordingly characterised in that flaps with free ends which may be placed tight against the housing walls project from the end faces and/or longitudinal side faces.

The filter element is preferably latched into the upper part of a filter housing, in other words on the clean air side. The free ends of the flaps then point against the direction of flow of the air. According to the invention it has been found that flaps with free ends are pivotally linked to the filter medium. Air entering on the inlet side can therefore pivot the moving flaps about the fixed end thereof and press the free ends against the housing walls. It has been found, in particular, that despite very high air throughputs of up to 1,000 kg/h and pressure differences between inlet side and outlet side of up to 50 mbar, which characteristically occur in the filtration of the air supplied to the engine, a shorter element with flaps made of non-woven fabric may be used. According to the invention, expensive polyurethane caterpillar tracks which have to be sprayed onto the filter medium or the filter element in a complex manner can be dispensed with. The flaps made of non-woven fabric further provide a filter medium which additionally filters the air supplied to the motor vehicle engine. A reliable seal is therefore ensured even with high air throughputs and high pressure differences between inlet side and outlet side.

The flaps could be formed as V flaps which define, with the longitudinal side faces and/or end faces, spaces having a V-shaped cross-section. V flaps may be moved or spread apart particularly easily by the incoming air supply and rest tight against the housing walls of the filter housing.

Against this background, latch projections which engage behind the flaps could be formed in the housing walls. This specific configuration ensures that the filter element may easily be captively latched during assembly without having to be fixed by hand while a lower part of the filter housing is fitted. The latch projections further form, with the V flaps, a wedge-shaped space in which incoming air can accumulate. The latch projections keep the filter element stable against displacement during vibration of the vehicle engine. Vertical shifting of the filter element in the filter housing is thus secured.

The flaps could be formed integrally with the end faces and/or the longitudinal side faces, the flaps each forming a first movable free arm with a free end and the end faces and/or the longitudinal side faces each forming two arms which are fixed to the filter medium. With this specific configuration, a strip which is folded into a V may easily be fixed to the filter medium by welding or adhesion, the flap projecting as a movable element. The integral configuration of the flaps with the longitudinal side faces or end faces allows simple production.

The flaps could comprise arcuate bend regions which have the same thickness as the flaps. With this specific configuration, the flaps have a high rebound capacity and can in fact exert a sufficiently high force on the housing walls to fix the filter element. Against this background, it is specifically conceivable that the flaps are of such a thickness that the filter element can become jammed in the filter housing without the presence of latch projections.

The arcuate bend regions could rest against stops. A further sealing point is produced by this specific configuration.

The flaps could be pressed against the housing walls. The pressure ensures that the non-woven fabric from which the flaps are produced is compressed and can therefore form a sealing point against the housing walls.

The filter housing could consist of an upper part and a lower part which, when assembled, form a passage which is interrupted by the filter medium. The air supply to be filtered for a motor vehicle engine can pass through the passage.

The filter arrangement described here is advantageously used to filter the air supplied to a motor vehicle engine. This use is surprisingly possible even though filter elements with polyurethane caterpillar tracks are conventionally used in engine air supply filtration. It has unexpectedly been found that flaps made of non-woven fabric can withstand the high air throughputs of up to 200 to 1,000 kg/h and very high pressure differences between inlet side and outlet side of 5 to 50 mbar.

The filter medium described here, the flaps and the end faces and/or the longitudinal side faces are preferably produced from a non-woven fabric. Non-woven fabrics can easily be stuck or welded together. In addition, a filter element constructed of a uniform non-woven fabric can easily be disposed of.

Generally preferred configurations and developments of the teaching are described in conjunction with the description of the preferred embodiment of the invention with reference to the drawings.

### BRIEF DESCRIPTION OF THE DRAWINGS

In the drawings

FIG. 1 is a perspective view of a filter element having V flaps projecting from its longitudinal side faces, and

FIG. 2 is a side view of a filter arrangement in which the V flaps of the filter element engage behind latch projections of the filter housing.

### DETAILED DESCRIPTION

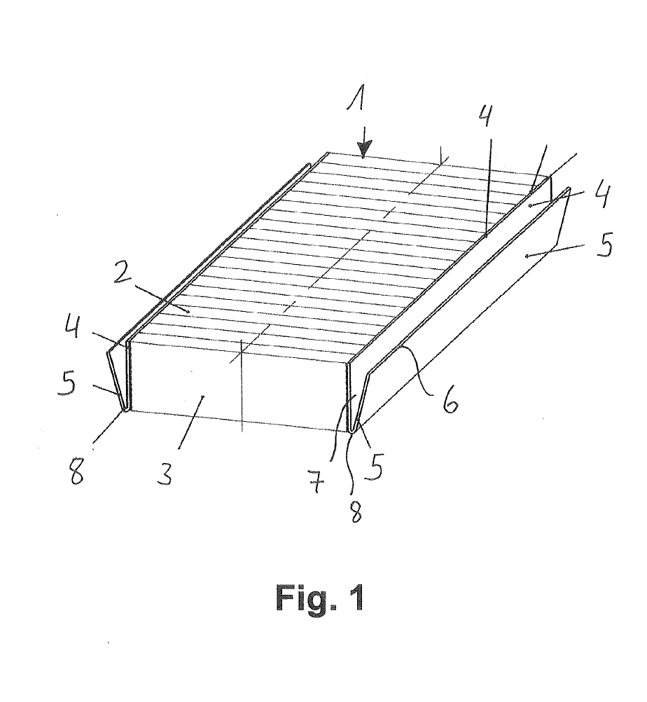

FIG. 1 shows a filter element 1 with a pleated filter medium 2, the pleated filter medium 2 having end faces 3 and longitudinal side faces 4. Flaps 5 with free ends 6 project from the longitudinal side faces 4. The flaps 5 are formed as V flaps which define, with the longitudinal side faces 4, spaces 7 having a V-shaped cross-section.

The flaps 5 are formed integrally with the longitudinal side faces 4, the flaps 5 forming movable free first arms with free ends 6 and the longitudinal side faces 4 each forming second arms which may be fixed to the filter medium 2. The free ends 6 are able to pivot relative to the longitudinal side faces 4.

The flaps 5 comprise arcuate bend regions 8 which have the same thickness as the flaps 5.

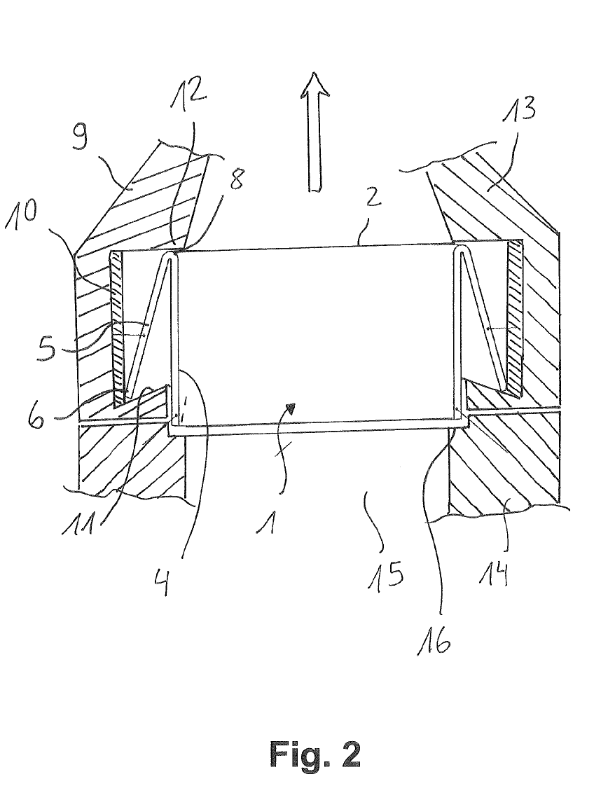

FIG. 2 is a side view of a filter arrangement for filtering the air supply to a motor vehicle engine. The air supply is guided through the filter arrangement in the direction of the arrow shown. The arrow is arranged at the outlet side.

Specifically, FIG. 2 shows a filter arrangement for filtering the air supply to a motor vehicle engine comprising a filter element 1 with a pleated filter medium 2, the pleated filter medium 2 having end faces 3 and longitudinal side faces 4, and a filter housing 9 for receiving the filter element 1, the filter housing 9 having housing walls 10. Flaps 5 with free ends 6 which rest tight against the housing walls 10 project from the longitudinal side faces 4. Latch projections 11, which engage behind the flaps 5, are formed in the housing walls 10. The latch projections 11 project from the housing walls 10 in the direction of the filter medium 2.

The flaps 5 comprise arcuate bend regions 8 which have the same thickness as the flaps 5. The arcuate bend regions 8 press against stops 12. The flaps 5 press against the housing walls 10.

The filter housing 9 consists of an upper part 13 and a lower part 14 which, when assembled, form a passage 15 which is interrupted by the filter medium 2. The filter element 1 rests on a shoulder 16 of the lower part 14.

Further advantageous configurations and developments of the teaching of the invention may be found, one the one hand, in the general part of the description and, on the other hand, in the claims.

What is claimed is:

1. A filter arrangement for filtering an air supply to a motor vehicle engine comprising:
a filter element having a pleated filter medium, the pleated filter medium having an end face and a longitudinal side face, at least one of the end face and the longitudinal side face having a flap with a free end projecting from the respective face; and
a filter housing receiving the filter element and having a housing wall, wherein the flap is configured to be placed tight against the housing wall.

2. The filter arrangement as recited in claim 1, wherein the flap is formed as a V-flap and defining a space having a V-shaped cross section with at least one of the end face and the longitudinal side face.

3. The filter arrangement as recited in claim 1, wherein the housing wall includes a latch projection engaging behind the flap.

4. The filter arrangement as recited in claim 1, wherein the flap is integrally formed with the respective end face or longitudinal side face so as to form a movable free first arm, and wherein at least one of the end face and the longitudinal side face forms a second arm fixed to the filter medium.

5. The filter arrangement as recited in claim 1, wherein the flap includes an arcuate bend region having a thickness the same as a flap thickness.

6. The filter arrangement as recited in claim 5, wherein the arcuate bend region rests against a stop of the filter housing.

7. The filter arrangement as recited in claim 1, wherein the flap presses against the housing wall.

8. The filter arrangement as recited in claim 1, wherein the filter housing includes an upper part and a lower part configured to form a passage when assembled, the passage being interrupted by the filter medium.

9. The filter arrangement as recited in claim 1, wherein the lower part includes a shoulder, and wherein the filter element rests on the shoulder.
